(19) United States
(12) Patent Application Publication
(10) Pub. No.: US 2022/0309275 A1
(43) Pub. Date: Sep. 29, 2022

(54) EXTRACTION OF SEGMENTATION MASKS FOR DOCUMENTS WITHIN CAPTURED IMAGE

(71) Applicant: Hewlett-Packard Development Company, L.P., Spring, TX (US)

(72) Inventors: Lucas Nedel Kirsten, Porto Alegre (BR); Ricardo Ribani, Barueri (BR); Rafael Borges, Porto Alegre (BR)

(21) Appl. No.: 17/215,305

(22) Filed: Mar. 29, 2021

(51) Int. Cl. G06K 9/00; G06K 9/20

(52) U.S. Cl. CPC G06K 9/00463; G06K 9/2081

(57) ABSTRACT

A point extraction machine learning model is applied to a captured image of one or multiple documents to identify the documents within the captured image and to identify boundary points for each document. For each document identified within the captured image, an instance segmentation machine learning model is applied to the boundary points for the document and to the captured image to extract a segmentation mask for the document.

### BACKGROUND

While information is increasingly communicated in electronic form with the advent of modern computing and networking technologies, physical documents, such as printed and handwritten sheets of paper and other physical media, are still often exchanged. Such documents can be converted to electronic form by a process known as optical scanning. Once a document has been scanned as a digital image, the resulting image may be archived, or may undergo further processing to extract information contained within the document image so that the information is more usable. For example, the document image may undergo optical character recognition (OCR), which converts the image into text that can be edited, searched, and stored more compactly than the image itself.

### BRIEF DESCRIPTION OF THE DRAWINGS

FIG. 1 is a diagram of an example process for extracting segmentation masks for documents within a captured image.

FIGS. 2A, 2B, 2C, 2D, 2E, and 2F are diagrams of example performance of the process of FIG. 1.

FIGS. 3A and 3B are example point extraction and instance segmentation models, respectively, which can be used in the process of FIG. 1.

FIG. 4 is a diagram of an example non-transitory computer-readable data storage medium storing program code for extracting segmentation masks for documents within a captured image.

FIG. 5 is a block diagram of an example computing device that can extract segmentation masks for documents within a captured image.

### DETAILED DESCRIPTION

As noted in the background, a physical document can be scanned as a digital image to convert the document to electronic form. Traditionally, dedicated scanning devices have been used to scan documents to generate images of the documents. Such dedicated scanning devices include sheetfed scanning devices, flatbed scanning devices, and document camera scanning devices, as well as multifunction devices (MFDs) or all-in-one (AlO) devices that have scanning functionality in addition to other functionality such as printing functionality. However, with the near ubiquitousness of smartphones and other usually mobile computing devices that include cameras and other types of image-capturing sensors, documents are often scanned with such non-dedicated scanning devices.

When scanning documents using a dedicated scanning device, a user may not have to individually feed each document into the device. For example, the scanning device may have an automatic document feeder (ADF) in which a user can load multiple documents. Upon initiation of scanning, the scanning device individually feeds and scans the documents, which may result in generation of an electronic file for each document or a single electronic file including all the documents. For example, the electronic file may be in the portable document format (PDF) or another format, and in the case in which the file includes all the documents, each document may be in a separate page of the file.

However, some dedicated scanning devices, such as lower-cost flatbed scanning devices as well as many document camera scanning devices, do not have ADFs. Non-dedicated scanning devices such as smartphones also lack ADFs. To scan multiple documents, a user has to manually position and cause the device to scan or capture images of the documents individually, on a per-document basis. Scanning multiple documents is therefore more tedious, and much more time consuming, than when using a dedicated scanning device that has an ADF.

Techniques described herein ameliorate these and other difficulties. The described techniques permit multiple documents to be concurrently scanned, instead of having to individually scan or capture images of the documents on a per-document basis. A dedicated scanning device or a non-dedicated scanning device can be used to capture an image of multiple documents. For example, multiple documents can be positioned on the platen of a flatbed scanning device and scanned together as a single captured image, or the camera of a smartphone can be used to capture an image of the documents as positioned on a desk or other surface in a non-overlapping manner.

The described techniques extract segmentation masks that correspond to identified documents within the captured image, permitting the documents to be segmented into different electronic files or as different pages of the same file. A segmentation mask for a document is a mask that has edges corresponding to the edges of the document. Therefore, applying the segmentation mask for a document against the captured image generates an image of the document. The segmentation masks for the identified documents within the captured image are thus individually applied to the captured image of all the documents to generate images that each correspond to one of the documents.

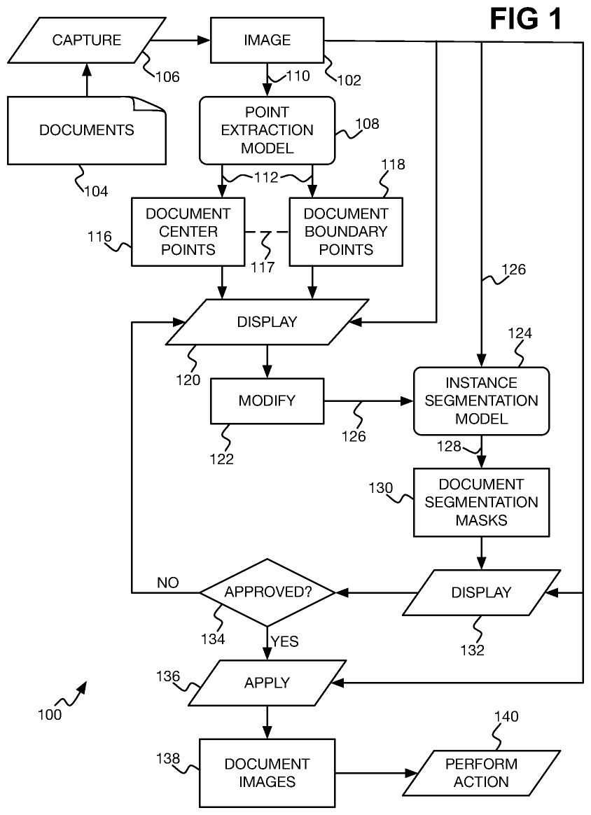

FIG. 1 shows an example process 100 for extracting segmentation masks for one or multiple documents 104 within the same captured image 102. The image 102 of the documents 104 is captured (106), such as by using a flatbed scanning device or other dedicated scanning device, or by using a non-dedicated scanning device such as a smartphone having a camera or other type of image capturing sensor. If there are multiple documents 104, they are positioned in such a way so that the documents 104 do not overlap before the image 102 of them is captured. The captured image 102 may be an electronic image file format such as the joint photographic experts group (JPEG) format, the portable network graphics (PNG) format, or another file format.

A point extraction machine learning model 108 is applied (110) to the captured image 102 of the documents 104 to identify (112) the documents 104 via their respective center points 116 within the captured image 102 as well as boundary points 118 for each identified document 104. For example, the captured image 102 may be input into the point extraction model 108. The model 108 then responsively outputs the center points 116 of the documents 104 and the boundary points 118 for each document 104 for which a center point 116 has been identified. Each center point 116 thus corresponds to a document 104 and is associated (117) with a set of boundary points 118 of the document 104 in question.

The point extraction machine learning model 108 is said to identify the documents 104 within the captured image 102 insofar as the model 108 identifies a center point 116 of each document 104 within the image 102. The center point 116 of a document 104 within the captured image 102 is the precise or approximate center of the document 104 within the image 102. For each document 104 that the point extraction model 108 has identified via a center point 116, the model 108 provides a set of boundary points 118. Each boundary point 118 of a document 104 is a point on an edge of the document 104 within the captured image 102.

The center points 116 of the documents 104 and their associated sets of boundary points 118 may be displayed (120) in an overlaid manner on the captured image 102. A user may then be permitted to modify the boundary points 118 for each document 104 identified by a corresponding center point 116 (122). For example, the user may be permitted to remove erroneous boundary points 118 that are not the edges of a document 104, or move such boundary points 118 so that they are more accurately located on the edges of the document 104 in question. The user may be permitted to further add additional boundary points 118, so that the boundary points 118 of a document 104 accurately reflect every edge of each document 104.

A specific example of the point extraction machine learning model 108 is described later in the detailed description. The model 108 is a machine learning model in that it leverages machine learning to extract the document center points 116 and the document boundary points 118 within the captured image 102. For example, the model 108 may be a convolutional neural network machine learning model. The model 108 is a point extraction model in that it extracts points, specifically the document center points 116 and the document boundary points 118.

For the documents 104 identified by the center points 116, an instance segmentation machine learning model 124 is applied (126) to the boundary points 118 of the documents 104 (as may have been modified) and the captured image 102 of all the documents 104 to extract (128) segmentation masks 130 for the identified documents 104. For instance, the boundary points 118 of the documents 104 may be input on a per-document basis, along with the captured image 102, into the instance segmentation model 124. The model 124 then responsively outputs on a per-document basis the segmentation masks 130 for the documents 104, where each mask 130 corresponds to one of the documents 104.

For example, if there are n documents 104 identified by the center points 116, then the instance segmentation machine learning model 124 is applied n times, once for each such identified document 104. To extract the segmentation mask 130 for the i-th document 104, where i=1 . . . n, the boundary points 118 for just this document 104 are input into the image segmentation model 124, along with the captured image 102 of all the documents 104. That is, the boundary points 118 for the other documents 104 are not input into the model 124.

A specific example of the instance segmentation machine learning model 124 is described later in the detailed description. The model 124 is a machine learning model in that it leverages machine learning to extract a document segmentation mask 130 for each document 104 identified within the captured image 102 by the point extraction model 108. For example, the model 124 may be a convolutional neural network machine learning model. The model 124 is an instance segmentation machine learning model in that the segmentation mask 130 extracted for a document 104 can be used to segment the captured image 102 in correspondence with this document 104, which is considered as an instance in this respect.

The segmentation masks 130 of the documents 104 may be displayed (132) in an overlaid manner on the captured image 102 for user approval. For instance, the user may not approve (134) of a segmentation mask 130 for a given document 104 if the mask 130 does not have edges that accurately correspond to the edges of the document 104 within the image 102. The process 100 may therefore revert back to displaying (120) the center point 116 and the boundary points 118 for any such document 104 for which a segmentation mask 130 has been disapproved.

In such instance, the user is therefore again afforded the opportunity to modify (122) the boundary points 118 for the disapproved documents 104. The instance segmentation model 124 is then reapplied (126) for each such document 104 on the basis of its newly modified boundary points 118 (and the captured image 102 itself) to reextract (128) the segmentation masks 130 for these documents 104. This iterative workflow permits segmentation masks 130 to be more accurately reextracted without having to recapture the image 102, permitting such reextraction of the masks 130 even if the documents 104 are no longer available for such recapture within a new image 102.

Existing segmentation mask extraction techniques, by comparison, may not permit a user to be extract a more accurate segmentation mask 130 for a document 104 without the user capturing a new image 102 of the document 104. If the document 104 is no longer available, such techniques are therefore unable to extract a more accurate segmentation mask 130 if the user disapproves of the initially extracted mask 130 for the document 104. By comparison, the process 100 provides for extraction of a potentially more accurate segmentation mask 130 by permitting the user to modify the boundary points 118 on which basis the instance segmentation model 124 extracts the mask 130, without having to capture a new image 102.

Upon user approval of the segmentation masks 130 for the documents 104 identified within the captured image 102 (134), the segmentation masks 130 are individually applied (136) to the captured image 102 to segment the image 102 into separate images 138 corresponding to the documents. That is, the segmentation mask 130 for a given document 104 is applied to the captured image 102 to extract a corresponding document image 138 from the image 102. The image 138 for each document 104 may be an electronic file in the same or different image file format as the electronic file of the captured image 102.

The process 100 can conclude by performing an action (140) on the individually extracted document images 138. For instance, the separate document images 138 may be saved in corresponding electronic image files, may be displayed to the user, or may be printed on paper or other printable media. Other actions that may be performed include image enhancement and/or processing, optical character recognition (OCR), and so on. For instance, the document images 138 may be individually rectified and/or deskewed, as two examples of image processing.

In this respect, the process 100 can provide for accurate segmentation of an identified document 104 within the captured image 102 even if the document 104 is skewed within the image 102. For example, a user may capture an image 102 of a page of a book as a document 104. The thicker the book is, the more difficult it will be to flatten book when capturing of an image 102 of the page of interest as the document 104 (particularly without damaging the binding of the book), and therefore the more skewed the document 104 is likely to be within the image 102.

The process 100 can provide for accurate segmentation of such a document 104 within the image 102. This is at least because the instance segmentation model 124 is operative on a set of boundary points 118 for the document 104 that can be user adjusted if the boundary points 118 as initially provided by the point extraction model 108 do not result in extraction of an accurate segmentation mask 130 for the document 104. By comparison, existing segmentation mask techniques may assume that a document 104 is rectangular, or at least polygonal, in shape within captured image 102, and therefore may not be able to provide for accurate segmentation of the document 104 if a document 104 is skewed within the image 102.

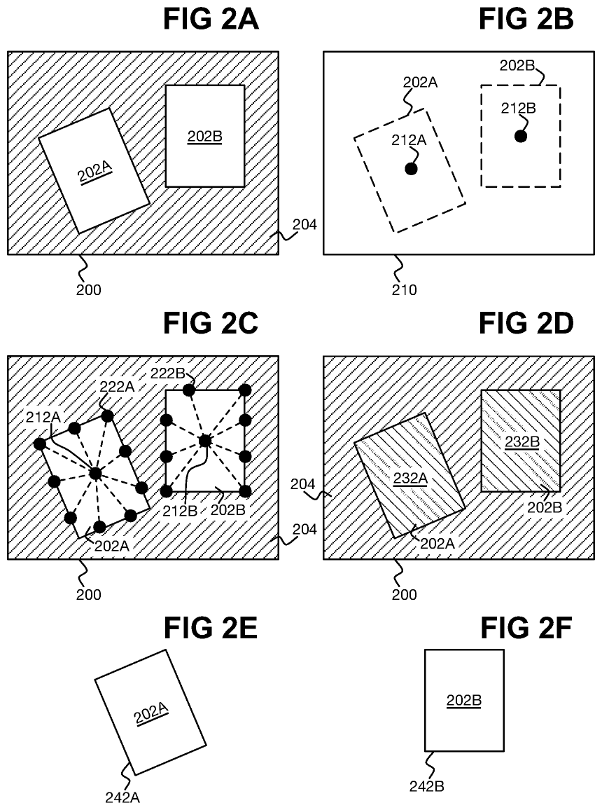

FIGS. 2A, 2B, 2C, 2D, 2E, and 2F illustratively depict example performance of the process 100. In FIG. 2A, a captured image 200 including two documents 202A and 202B against a background 204 is shown. The documents 202A and 202B are collectively referred to as the documents 202. Performance of the process 100 thus ultimately extracts a document image for each document 202, via application of extracted segmentation masks for the documents 202 from the captured image 200.

In FIG. 2B, a heatmap 210 of the center points 212A and 212B of the documents 202A and 202B, respectively, is shown. The center points 212 are collectively referred to as the center points 212. The documents 202 are not themselves part of the heatmap 210, and are depicted in FIG. 2B (in dotted line form) just for illustrative reference. The point extraction machine learning model 108 may generate the heatmap 210 in one implementation to identify the documents 202 via their center points 212.

The heatmap 210 may be a monochromatic or grayscale image of the same size as the captured image 200, in which pixels have increasing (or decreasing) pixel values in correspondence with their likelihood of being the actual center points 212 of the documents 202. Therefore, there may be a collection or cluster of pixels at the center of each document 202, with the center of the cluster, or the pixel having the highest (or lowest) pixel value, corresponding to the center point 212 in question. In the example of FIG. 2B, the center points 212 are black against a white background, but may instead be white against a black background.

In FIG. 2C, along with the center points 212 of the documents 202, a set of boundary points 222A of the document 202A and a set boundary points 222B of the document 202B are shown overlaid against the image 200 of the documents 202. The sets of boundary points 222A and 222B are collectively referred to as the sets of boundary points 222. Which document 202 each boundary point 222 is associated with can be indicated via a dotted lined between each boundary point 222 and the center point 212 of the document 202 in question. The point extraction machine learning model 108 extracts the boundary points 222 at the same time the model 108 extracts the center points 212 of the heatmap 210 to identify the documents 202.

The boundary points 222 identified by the point extraction model 108 may, but do not necessarily, include corner points of the documents 202. In general, each edge of a document 202 may have a sufficient number of boundary points 222 identified by the model 108 to define or accurately reflect the contour of the edge in question. As has been noted, the user may be afforded to the opportunity to adjust the boundary points 222 identified by the point extraction model 108 so that the boundary points 222 of the documents 202 are sufficiently indicated to result in accurate segmentation mask extraction.

In FIG. 2D, segmentation masks 232A and 232B for the documents 202A and 202B, respectively, are shown overlaid against the captured image 200. The segmentation masks 232A and 232B are collectively referred to as the segmentation masks 232. The instance segmentation model 124 individually extracts the segmentation mask 232 for each document 202 from the captured image 200 on the basis of the set of boundary points 222 for the document 202 in question. If the user does not approve the segmentation masks 232, the user is again permitted to modify the boundary points 222 for the disapproved documents 202, per FIG. 2C.

In FIGS. 2E and 2F, images 242A and 242B of the documents 202A and 202B, respectively, as extracted from the captured image 200 are shown. The document images 242A and 242B are collectively referred to as the document images 242. The segmentation mask 232A is applied against the captured image 200 to extract the image 242A of the document 202A in FIG. 2E, and the segmentation mask 232B is applied against the captured image 200 to extract the image 242B of the document 202B in FIG. 2F. Subsequent actions may then be individually performed on each extracted document image 242 as desired.

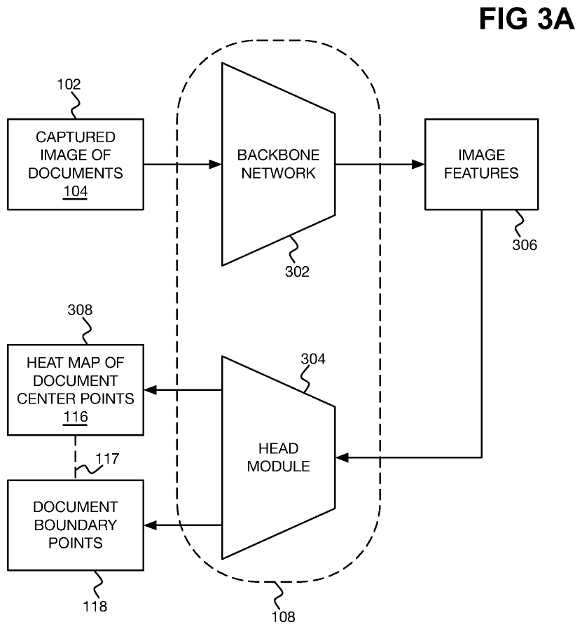

FIG. 3A shows an example point extraction machine learning model 108 that may be used in the process 100 of FIG. 1. The point extraction model 108 includes a backbone network 302 and a head module 304. The backbone network 302 may be a convolutional neural network, for instance, and extracts image features 306 from the captured image 102 of the documents 104 input into the backbone network 302. The head module 304 may be a feature pyramid network (FPN), for instance, and predicts or identifies a heat map 308 of the center points 116 of the documents 104 and the boundary points 118 of the documents 104 from the extracted image features 306.

The point extraction machine learning model 108 may leverage existing machine learning models. An example of such a machine learning model is described in Xie et al., “Polarmask: Single Shot Instance Segmentation with Polar Representation,” in Proceedings of the IEEE/CVF Conference on Computer Vision and Pattern Recognition (2020) (hereinafter, the “Polarmask reference”). However, the point extraction model 108 differs from the model used in the Polarmask reference in at least two ways.

First, the Polarmask reference identifies the center point of a single object within an image and this object's boundary points at regular polar angles around the center point, and then stitches or joins together the center boundary points to form a segmentation mask of the object. By comparison, the point extraction model 108 does not stitch or join together the boundary points 118 of each document 104 for which a center point 116 has been identified to generate a segmentation mask 130 for the document 104 in question. Rather, another machine learning model—the instance segmentation model 124—is applied to the captured image 102 and the boundary points 118 of each document 104 (on a per-document basis) to generate segmentation masks 130 for the documents 104.

Therefore, the segmentation masks 130 are generated in a different manner than that described in the Polarmask reference. Stated another way, the point extraction machine learning model 108 extracts the boundary points 118 for the documents 104 identified by their center points 116, and does not generate the segmentation masks 130, in contradistinction to the Polarmask reference. The utilization of another machine learning model—the instance segmentation model 124—has been demonstrated to provide for superior segmentation mask generation as compared to the approach used in the Polarmask reference.

Second, the Polarmask reference employs a residual neural network (ResNet) architecture as the backbone network 302, which is described in Targ et al., “Resnet in Resnet: Generalizing Residual Architectures,” arXiv: 1603.08029 (2016). By comparison, the point extraction machine learning model 108 may use a version of the MobileNetV2 architecture as the backbone network 302. This architecture is described in Mark Sandler et al., “MobileNetV2: Inverted Residuals and Linear Bottlenecks,” in Proceedings of the IEEE Conference on Computer Vision and Pattern Recognition (2018).

FIG. 3B shows an example instance segmentation machine learning model 124 that may be used in the process 100 of FIG. 1. The instance segmentation model 124 includes a backbone network 352 and a head module 354. The backbone network 352 may be a convolutional neural network, and extracts image features 356 from the captured image 102 of the documents 104 and the boundary points 118 for one such identified document 104 input in the network 352. The backbone network 352 may be of the same or different type of neural or other network as the backbone network 302 of the point extraction model 108. The head model 354 may be a pyramid scene parsing (PSP) network, and predicts or extracts the segmentation mask 130 for the document 104 within the captured image 102 from the extracted image features 356.

The instance segmentation machine learning model 124 may leverage existing machine learning models. An example of such a machine learning model is described in Maninis et al., “Deep Extreme Cut: From Extreme Points to Object Segmentation,” in Proceedings of the IEEE Conference on Computer Vision and Pattern Recognition (2018) (hereinafter, the “DEXTR reference”). However, the instance segmentation model 124 differs from the model used in the DEXTR reference in at least two ways.

First, the DEXTR reference extracts a segmentation mask of a single object within an image from the object's extreme boundary points as manually user input or specified. Specifically, the DEXTR reference requires that a user specify the corner points of an object. By comparison, the instance segmentation model 124 does not require manual user boundary point specification for each document 104, but rather leverages the boundary points 118 that are initially identified or extracted by the point extraction model 108. That is, another machine learning model—the point extraction model 108—is first applied to the captured image 102 to extract the boundary points 118 for each of one or multiple documents 104.

Moreover, because the DEXTR reference is not as well equipped to accommodate skewed documents 104 that have curved edges. Corner, or extreme, boundary points may not sufficiently define such edges of such documents 104, and having a user specify sufficient such points can require considerably more skill on the part of the user. A novice user, for instance, may be unable to identify which such boundary points 118 should be specified. The instance segmentation model 124 ameliorates this issue by having a different model—the point extraction model 108—provide initial extraction of the boundary points 118 of the documents 104.

Second, the DEXTR reference, like the Polarmask reference, employs a ResNet architecture as the backbone network 302. By comparison, the point extraction machine learning model 108 may use a version of the MobileNetV2 architecture as the backbone network 302. Such a backbone network 302 can better balance performance and size as compared to the ResNet architecture.

The usage of two machine learning models—a point extraction model 108 to initially extract the boundary points 118 of potentially multiple documents 104 and an image segmentation model 124 to then individually extract their segmentation masks 130—provides for demonstrably more accurate segmentation masks 130 as compared to the Polarmask or DEXTR reference alone. Furthermore, the workflow afforded by the process 100 of FIG. 1, in which a user can modify boundary points 118 if the resultantly extracted segmentation masks 130 do not accurately correspond to the documents 104, is an iterative technique that neither the Polarmask nor the DEXTR reference contemplates. In this way, too, the process 100 can generate more accurate segmentation masks 130 than either such reference alone can. Furthermore, neither reference specifically contemplates the identification of documents per se.

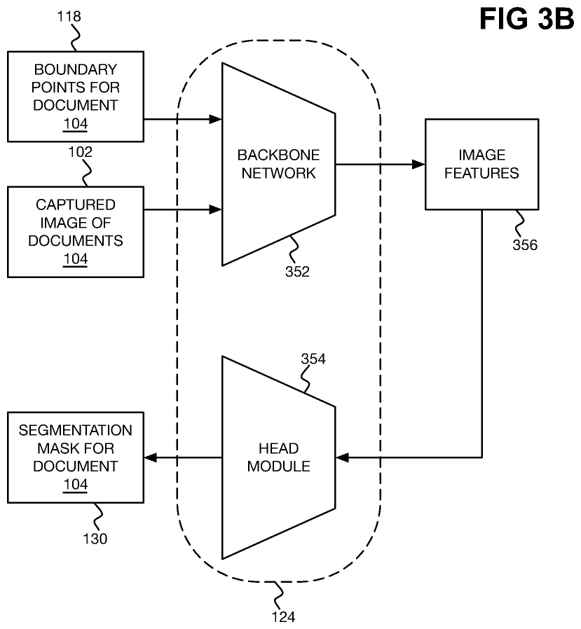

FIG. 4 shows an example non-transitory computer-readable data storage medium 400 storing program code 402 executable by a processor to perform processing. The processor may be part of a smartphone or other computing device that captures an image of one or multiple documents. The processor may instead be part of a different computing device, such as a cloud or other type of server to which the image-capturing device is communicatively connected over a network such as the Internet. In this case, the device that captures an image of one or multiple documents is not the same device that generates a segmentation mask for each document.

The processing includes applying a point extraction machine learning model to the captured image of one or multiple documents to identify the documents within the captured image and to identify boundary points for each document (404). The processing includes, for each document identified within the captured image, applying an instance segmentation machine learning model to the boundary points for the document and to the captured image to extract a segmentation mask for the document (406). As noted, the extracted segmentation masks can then be individually applied to the captured image to extract images corresponding to the documents from the captured image.

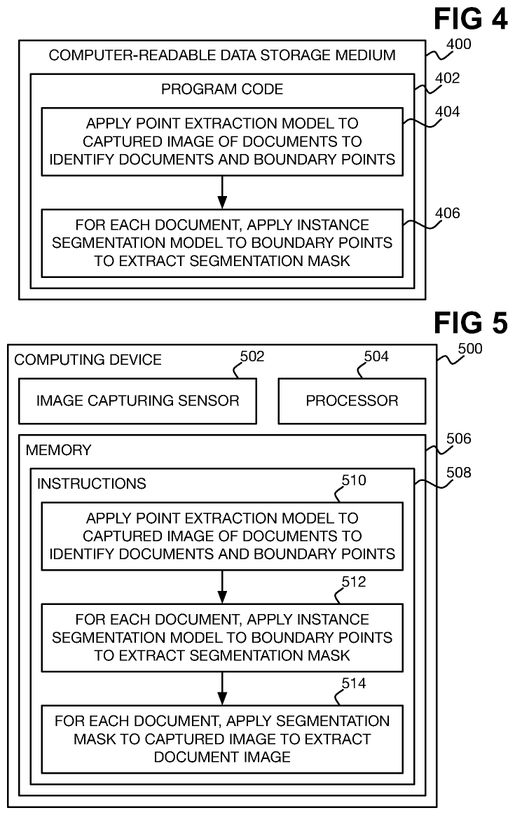

FIG. 5 shows an example computing device 500. The computing device 500 may be a smartphone or another type of computing device that can capture an image of a document. The computing device 500 includes an image capturing sensor 502, such as a digital camera, to capture an image of a document. The computing device 500 further includes a processor 504, and a memory 506 storing instructions 508.

The instructions 508 are executable by the processor 504 to apply a point extraction machine learning model to the captured image to identify the documents within the captured image and to identify boundary points for each document (510). The instructions 508 are executable by the processor 504 to, for each document identified within the captured image, then apply an instance segmentation machine learning model to the boundary points for the document and to the captured image to extract a segmentation mask for the document (512). The instructions 508 are executable by the processor 504 to, for each document identified within the captured image, subsequently apply the segmentation mask for the document to the captured image to extract an image of the document from the captured image (514).

Techniques have been described for extracting segmentation masks for one or multiple documents within a captured image. Multiple documents can therefore be more efficiently scanned. Rather than a user having to individually capture an image of each document, the user just has to capture one image of multiple documents (or multiple images that each include more than one document). Furthermore, the extracted segmentation masks accurately correspond to the documents, even if the documents are skewed within the captured image.

We claim:

1. A non-transitory computer-readable data storage medium storing program code executable by a processor to perform processing comprising:
applying a point extraction machine learning model to a captured image of one or multiple documents to identify the documents within the captured image and to identify a plurality of boundary points for each document; and
for each document identified within the captured image, applying an instance segmentation machine learning model to the boundary points for the document and to the captured image to extract a segmentation mask for the document.

2. The non-transitory computer-readable data storage medium of claim 1, wherein the processing further comprises:
for each document identified within the captured image, applying the segmentation mask for the document to the captured image to extract an image of the document from the captured image.

3. The non-transitory computer-readable data storage medium of claim 2, wherein the processing further comprises:
for each document identified within the captured image, performing an action on the image of the document extracted from the captured image.

4. The non-transitory computer-readable data storage medium of claim 1, wherein the processing further comprises:
prior to applying the instance segmentation machine learning model, displaying the boundary points for each document overlaid against the captured image; and
permitting a user to modify the boundary points for each document overlaid against the captured image.

5. The non-transitory computer-readable data storage medium of claim 1, wherein the processing further comprises:
after applying the instance segmentation machine learning model, displaying the segmentation mask for each document overlaid against the captured image;
in response to user disapproval of the segmentation mask for any document, displaying the boundary points for each document overlaid against the captured image;
permitting the user to modify the boundary points for each document overlaid against the captured image; and
for each document identified within the captured image, reapplying the instance segmentation model to the boundary points for the document and to the captured image to reextract the segmentation mask for the document.

6. The non-transitory computer-readable data storage medium of claim 5, wherein the segmentation mask for each document is reextracted using the captured image from which the segmentation mask was first extracted, such that the segmentation mask is reextracted without having to capture a new image of the documents.

7. The non-transitory computer-readable data storage medium of claim 1, wherein the point extraction machine learning model outputs a plurality of center points corresponding to the documents within the captured image in order to identify the documents within the captured image,
and wherein the point extraction machine model outputs the boundary points for each document in relation to the center point corresponding to the document.

8. The non-transitory computer-readable data storage medium of claim 7, wherein the center points are output by the point extraction machine learning model within a heatmap of the center points.

9. The non-transitory computer-readable data storage medium of claim 1, wherein the point extraction machine learning model comprises:
a backbone convolutional neural network that extracts image features from the captured image; and
a feature pyramid network head module to the backbone convolutional neural network that identifies the documents and the boundary points for each document from the extracted image features.

10. The non-transitory computer-readable data storage medium of claim 1, wherein the instance segmentation machine learning model comprises:
a backbone convolutional neural network that extracts image features from the captured image based on the boundary points for each document identified within the captured image; and
a pyramid scene parsing head module to the backbone convolutional neural network that extracts the segmentation mask for each document identified within the captured image from the extracted image features.

11. The non-transitory computer-readable data storage medium of claim 1, wherein the point extraction machine learning model and the instance segmentation machine learning model each comprises a backbone convolutional neural network that extracts image features from the captured image,
wherein the backbone convolutional neural network of the point extraction machine learning model is of a same or different type of neural network than the backbone convolutional neural network of the instance segmentation machine learning model.

12. A computing device comprising:
an image capturing sensor to capture an image of one or multiple documents;
a processor; and
a memory storing instructions executable by the processor to:
apply a point extraction machine learning model to the captured image to identify the documents within the captured image and to identify a plurality of boundary points for each document; and
for each document identified within the captured image, apply an instance segmentation machine learning model to the boundary points for the document and to the captured image to extract a segmentation mask for the document; and
for each document identified within the captured image, apply the segmentation mask for the document to the captured image to extract an image of the document from the captured image.

13. The computing device of claim 12, wherein the instructions are executable by the processor to further:
for each document identified within the captured image, perform an action on the image of the document extracted from the captured image.

14. The computing device of claim 12, wherein the instructions are executable by the processor to further:
prior to applying the instance segmentation machine learning model, display the boundary points for each document overlaid against the captured image; and
permit a user to modify the boundary points for each document overlaid against the captured image.

15. The computing device of claim 12, wherein the instructions are executable by the processor to further:
after applying the instance segmentation machine learning model, display the segmentation mask for each document overlaid against the captured image;
in response to user disapproval of the segmentation mask for any document, display the boundary points for each document overlaid against the captured image;
permit the user to modify the boundary points for each document overlaid against the captured image; and
for each document identified within the captured image, reapply the instance segmentation model to the boundary points for the document and to the captured image to reextract the segmentation mask for the document.
